(19) United States
(12) Patent Application Publication
(10) Pub. No.: US 2007/0090075 A1
(43) Pub. Date: Apr. 26, 2007

(54) Container crane with two carriers for lifting two 40 foot containers

(76) Inventor: Hong Tian, Shanghai (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/434,549

(22) Filed: May 15, 2006

Related U.S. Application Data
(63) Continuation of application No. PCT/CN05/01643, filed on Oct. 8, 2005.

(51) Int. Cl. B66C 17/00

(52) U.S. Cl. 212/312

(57) ABSTRACT

The invention relates to a container crane with two carriers for lifting two 40 foot containers, wherein the container crane comprises: a front carrier and a back carrier, the front carrier is mounted on the upper rail of a large beam and is able to travel on the upper rail, the back carrier is mounted on the lower rail of a gate frame transverse beam and is able to travel on the lower rail; an intermediate transfer platform having container locations is mounted under the gate frame transverse beam; when unloading the containers, the front carrier lifts and transfers two 40 foot containers to the intermediate transfer platform along the upper rail, the back carrier lifts and transfers the two 40 foot containers on the intermediate transfer platform to a ground transportation truck; when loading the containers, it is vice versa. The front carrier of the container crane of the present invention can load and unload two 40 foot containers side by side at a time easily while protect the containers from swing during the loading and unloading orientation of the container between the crane and the ground transportation truck. The speed and efficiency of loading and unloading of the containers between the container ships, the container cranes and the ground transportation trucks is increased by using the container crane of the present invention. The container crane of the present invention may be used at an automatic container dock, or a conventional container dock such that it has a hot prospect and a wide application field.

### CROSS-REFERENCE TO RELATED APPLICATION(S)

This application is a continuation of International application number PCT/CN2005/001643 filed Oct. 8, 2005, the contents are herein incorporated in their entirety by reference.

### FIELD OF INVENTION

The invention generally relates to container crane, more particularly, relates to a container crane with two carriers for lifting two 40 foot containers.

### BACKGROUND OF INVENTION

The increasing requirements of container transportation in the world and the continuous increment of the handling capacity of the container port put forward new and increased demands on the technical equipment for loading and unloading containers, and an urgent need for the design and development of high efficient bank-run container load and unload systems to meet the demand of the lifter productivity needed by the larger ships.

Both the crane with two carriers and the crane for lifting two 40 foot containers are available nowadays these two types of container cranes have their own advantages. If a new type of container cranes with both advantages of the two types of the cranes is provided by combining the crane with two carriers and the crane for lifting two 40 foot containers, the loading and unloading efficiency of the container crane will be further increased.

### SUMMARY OF INVENTION

It is an object of the invention to provide a improved container crane with two carriers for lifting two 40 foot containers to resolve the problem that the container crane for lifting two 40 foot containers does not have two carriers and the container crane with two carriers can not lift two 40 foot containers simultaneously.

According to the present invention, providing a container crane with two carriers for lifting two 40 foot containers, wherein the container crane comprises: a front carrier and a back carrier, the front carrier is mounted on the upper rail of a large beam and is able to travel on the upper rail, the back carrier is mounted on the lower rail of a gate frame transverse beam and is able to travel on the lower rail; an intermediate transfer platform having container locations is mounted under the gate frame transverse beam; when unloading the containers, the front carrier lifts and transfers two 40 foot containers to the intermediate transfer platform along the upper rail, the back carrier lifts and transfers the two 40 foot containers on the intermediate transfer platform to a ground transportation truck; when loading the containers, it is vice versa.

The container crane with two carriers for lifting two 40 foot containers according to the present invention is a improvement and creation based on the container crane with two carriers and the container crane for lifting two 40 foot containers, this new type container crane has the advantages of both the container crane with two carriers and the container crane for lifting two 40 foot containers while overcomes their drawbacks. By using the present invention, the loading and unloading efficiency of the container crane to container ships is increased significantly and the matching of the container crane with the ground transportation truck is also improved, increasing the whole operation efficiency of the container crane.

The front carrier of the container crane of the present invention can load and unload two 40 foot containers side by side simultaneously, while the low lifting height and the short travel distance of the back carrier will protect the containers from swing during the loading and unloading orientation, thus the loading and unloading speed of the container crane and the ground transportation truck is also increased.

The container crane of the present invention may be used at an automatic container dock or a conventional container dock, having a hot prospect and a wide application field.

### BRIEF DESCRIPTION OF THE DRAWINGS

FIG. 1 is the schematic structure of a container crane with two carriers for lifting two 40 foot containers according to the invention.

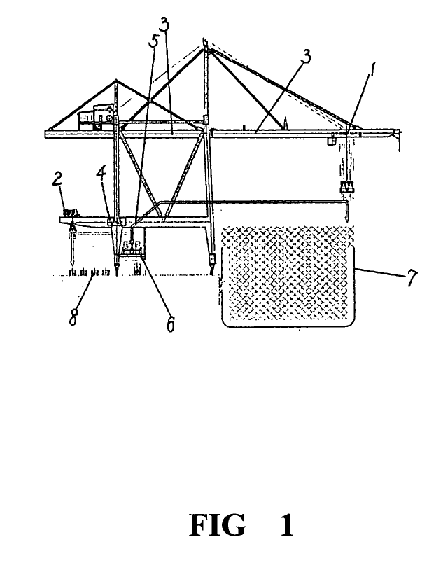

### DETAILED DESCRIPTION OF PREFERRED EMBODIMENTS

With reference to the figure, a container crane with two carriers for lifting two 40 foot containers according to the invention is equipped with two carriers being able to travel on an upper rail and a lower rail respectively. The two carries are one front carrier and one back carrier, the front carrier 1 is mounted on the upper rail 3 of the large beam and may travel on the rail. The front carrier rail 3 is arranged on the front and back large beams of the crane and the height of the rail is the normal height of the conventional crane, and the front carrier 1 performs loading and unloading of the container between the container ship and the intermediate transfer platform. The back carrier 2 is mounted on the lower rail of the gate frame transverse beam 5 and may travel on the rail, the height position of the back carrier rail 4 is close to the ground, and the back carrier 2 performs loading and unloading of the container between the ground transportation truck and the intermediate transfer platform.

An intermediate transfer platform 6 having container locations is arranged at the optimum position under the gate frame transverse beam 5. The front carrier 1 can lift and transfer two 40 foot containers on the container ship 7 side by side to the intermediate transfer platform 6 simultaneously along the operation rail 3, or the front carrier 1 can lift and transfer two 40 foot containers on the intermediate transfer platform 6 side by side to the container ship 7 simultaneously. Since the front carrier can lift two 40 foot containers at a time, the productive efficiency of the crane will be two times of the conventional crane. The front carrier can also load and unload four 20 foot containers at a time, or one 40 foot container and two 20 foot containers at a time. Of course, the front carrier of the present invention may load and unload one 20 foot container, or one 40 foot container, or one 45 foot container, or one 53 foot container as the conventional crane does.

The back carrier 2 can lift and transfer the containers on the intermediate transfer platform 6 to the ground transportation truck 8 one by one along the operation rail 4, or the back carrier 2 can lift and transfer the containers on the ground transportation truck 8 to the intermediate transfer platform 6 one by one. The low rail 4 is arranged by using the structural feature of the crane itself wisely such that the height of the low rail from the ground is decreased significantly, the operation distance of the carrier is shortened, therefore, the back carrier has the optimum lifting height and operation distance, the alignment between the crane and the ground transportation truck is easy, the swing of the loading and unloading orientation is prevented, and the speed and the efficiency of the loading and unloading are increased.

All-automatic operation without manual manipulation may be used by the relay operation of the two carriers using the intermediate transfer platform, the combined operation model of the manual manipulation and the remote manipulation may be used according to the requirement of the user. The intermediate transfer platform can implement installation and uninstallation of the four corner lock pins of the container except the intermediate transfer relay function of the two carriers, the installation and uninstallation of the four corner lock pins of the container can be completed on the intermediate transfer platform by the worker, that is, the installation and uninstallation time of the corner lock pins of the container does not occupy the operation cycle time by virtue of the time difference of the relay operation of the two carriers so that the loading and unloading efficiency of the crane is increased. In the operation of the conventional crane, the installation and uninstallation of the corner lock pins of the container is carried out by the worker on the ground when the carrier hanging the container is adjacent to the ground, and the carrier may come into next cycle only after the installation and uninstallation of the corner lock pins of the container has been completed by the worker. In the operation of the crane of the invention, after the front carrier of the crane has lifted and transmitted the container onto the intermediate transfer platform, the front carrier may leave and come into next cycle immediately so that the time of taking out the lock pins in the front carrier operation cycle is omitted.

Since the lifting height and the travel distance of the back carrier are very short, its operation cycle is about half of a operation cycle of the front carrier so that its efficiency is matched with that of the front carrier.

1. A container crane with two carriers for lifting two 40 foot containers, wherein the container crane comprises:
a front carrier and a back carrier, the front carrier is mounted on the upper rail of a large beam and is able to travel on the upper rail, the back carrier is mounted on the lower rail of a gate frame transverse beam and is able to travel on the lower rail;
an intermediate transfer platform having container locations is mounted under the gate frame transverse beam;
when unloading the containers, the front carrier lifts and transfers two 40 foot containers to the intermediate transfer platform along the upper rail, the back carrier lifts and transfers the two 40 foot containers on the intermediate transfer platform to a ground transportation truck;
when loading the containers, it is vice versa.
